(19) United States
(12) Patent Application Publication
(10) Pub. No.: US 2011/0157338 A1
(43) Pub. Date: Jun. 30, 2011

(54) STEREOSCOPIC DISPLAY DEVICE WITH RECIPROCATING LENTICULAR LENS SCREEN

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/841,982

(22) Filed: Jul. 22, 2010

(30) Foreign Application Priority Data
Dec. 30, 2009 (CN) 200910312689.0

(51) Int. Cl. H04N 13/04; G02B 27/22

(52) U.S. Cl. 348/59; 359/463; 348/E13.075

(57) ABSTRACT

A reciprocating lenticular lens screen assembly includes a lenticular lens screen and a driving assembly. The lenticular lens screen includes a substrate and an optical portion formed on a first major face of the substrate for viewing by a viewer at a viewer's position. The optical portion is configured for transmitting light rays representing images to the viewer's position at angles corresponding to a right eye viewing position of the viewer's position and at angles corresponding to a left eye viewing position of the viewer's position. A part of the driving assembly is connected to the substrate, and the driving assembly moves the lenticular lens screen back and forth at a predetermined frequency to show the images to the right eye viewing position and to the left eye viewing position alternately at the predetermined frequency. A stereoscopic display device incorporating the lenticular lens screen is also provided.

### BACKGROUND

1. Technical Field

The present disclosure relates to display devices and, particularly, to a stereoscopic display device with a reciprocating lenticular lens screen assembly.

2. Description of Related Art

Typically, stereoscopic imaging systems utilize special parallax barrier screens such as eyewear, to ensure that the viewer can perceive the correct images appropriate for each eye. However, it is inconvenient to use such an accessory.

Therefore, a stereoscopic display device which can overcome the above-mentioned problem is desired.

### BRIEF DESCRIPTION OF THE DRAWINGS

In the drawings, all the views are schematic.

FIG. 1 is an isometric, assembled view of a stereoscopic display device with a lenticular lens screen assembly, according to an exemplary embodiment.

FIG. 2 is a cross-sectional view of the stereoscopic display device of FIG. 1, taken along line II-II thereof.

FIG. 3 is an exploded view of the stereoscopic display device of FIG. 1.

FIG. 4 is essentially an isometric view of the lenticular lens screen and part of a driving assembly of the stereoscopic display device of FIG. 1.

FIG. 5 is a plan view showing exemplary optical viewing paths for an image displayed on a liquid crystal display (LCD) panel of the stereoscopic display device of FIG. 1 when the lenticular lens screen of FIG. 1 is moved back and forth between a left eye viewing position and a right eye viewing position.

### DETAILED DESCRIPTION

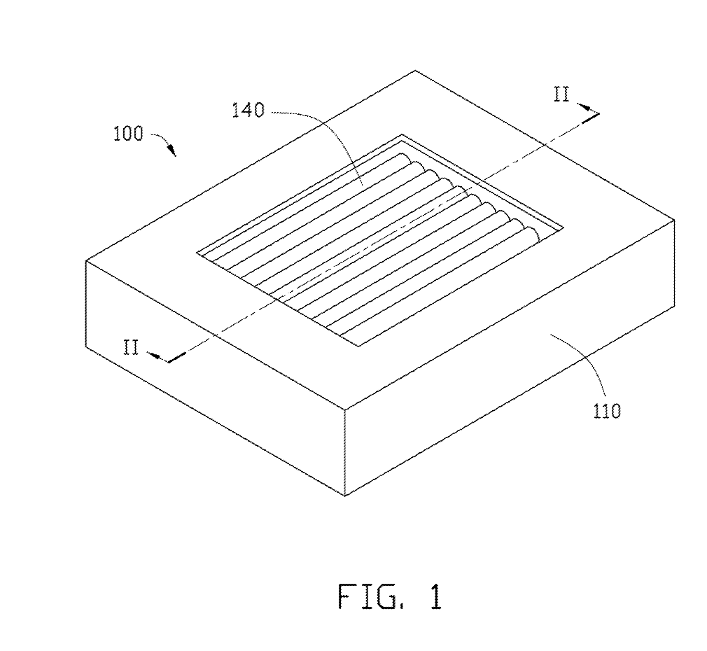

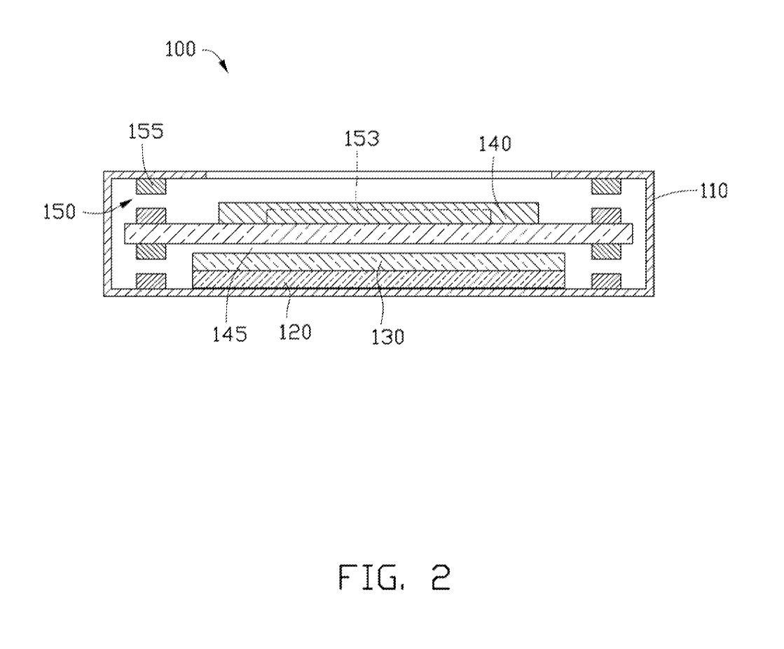

Referring to FIGS. 1 and 2, a stereoscopic display device 100, according to an exemplary embodiment, includes an enclosure 110, a backlight module 120, a liquid crystal display (LCD) panel 130, a lenticular lens screen 140, and a driving assembly 150. The backlight module 120, the LCD panel 130, and the lenticular lens screen 140 are stacked in turn and received in the enclosure 110 together with the driving assembly 150. Part of the driving assembly 150 is connected to the lenticular lens screen 140, and the driving assembly 150 is configured for driving the lenticular lens screen 140 to move relative to the LCD panel 130 along directions parallel to the LCD panel 130.

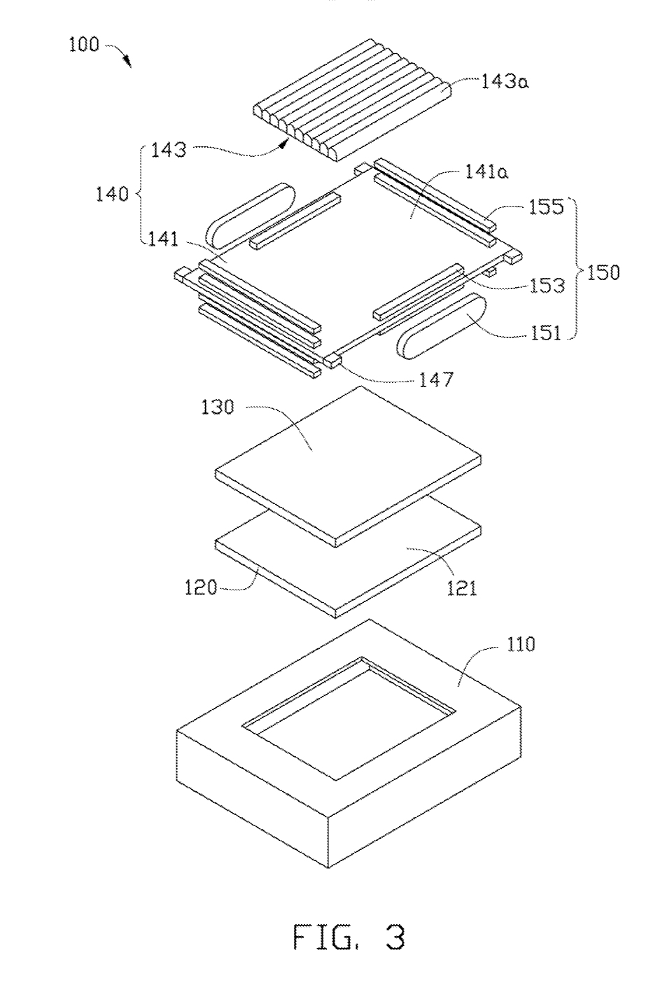

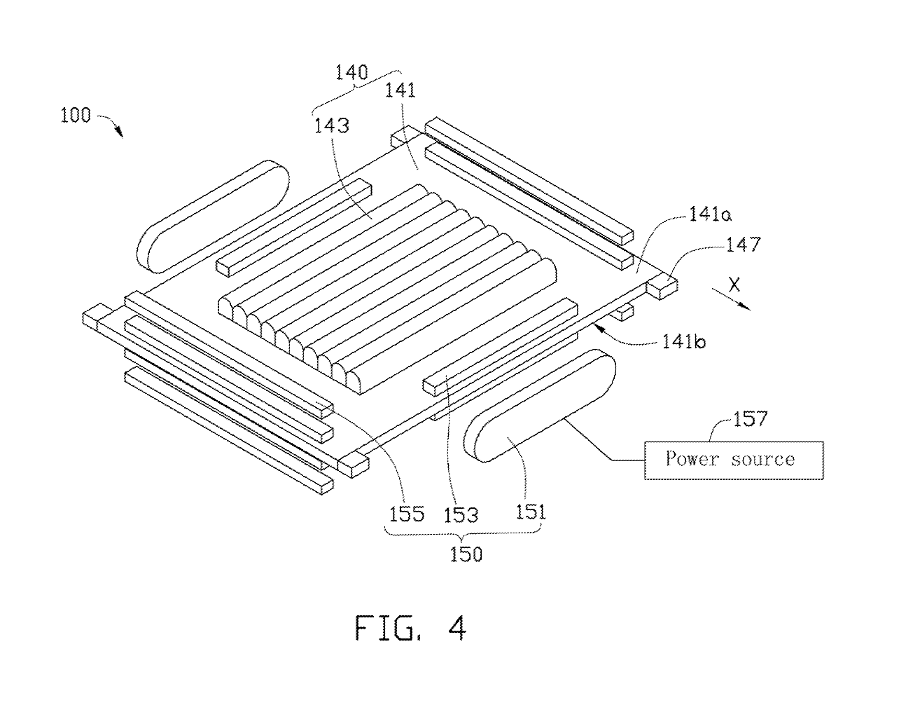

Referring also to FIGS. 3 and 4, the backlight module 120 includes a light emitting surface 121, which abuts or is attached to the LCD panel 130 and is configured for transmitting uniform and continuous light rays to the LCD panel 130. The backlight module 120 also includes a plurality of cold cathode fluorescence lamps (or light emitting diodes), and various optical plates as known in the art.

The LCD panel 130 is surrounded by the enclosure 110 (see FIG. 2) and supported on the backlight module 120. In the present embodiment, the rear (bottom) surface of the LCD panel 130 away from the lenticular lens screen 140 contacts the light emitting surface 121 of the backlight module 120. In some embodiments, the LCD panel 130 can be adhered to the inner surface of the enclosure 110. The LCD panel 130 is configured for consecutively and alternately displaying a number of 2-D graphic images captured for right eye viewing and left eye viewing, respectively, or a number of synthesized stereoscopic images. In the present embodiment, the LCD panel 130 consecutively and alternately displays two dissimilar 2-D graphic visual images obtained by two cameras for each vision (i.e. right eye vision, left eye vision), with each single display of each graphic visual image persisting for a predetermined time interval. The predetermined time interval is very short, so as to achieve persistence of vision for the human eye (see also below).

The lenticular lens screen 140 is positioned above the LCD panel 130 and faces a viewer. The lenticular lens screen 140 includes a substrate 141, and an optical portion 143 precisely formed on the substrate 141.

The substrate 141 of the lenticular lens screen 140 is made of transparent glass, and configured for transmitting the light rays from the LCD panel 130 to the optical portion 143. The size of the substrate 141 depends primarily on that of the LCD panel 130. In the present embodiment, the substrate 141 is substantially rectangular shaped, and the length and width of the substrate 141 are the same as those of the LCD panel 130. Typically, the substrate 141 has a width in a range from about 10 inches to about 40 inches. In certain embodiments, the substrate 141 has a width from about 12 inches to about 20 inches. The substrate 141 is substantially parallel to the LCD panel 130. A gap 145 (seen in FIG. 2) is defined between the substrate 141 and the LCD panel 130 for avoiding friction that would otherwise occur between the substrate 141 and the LCD panel 130. The width of the gap 145 is in the range from about 0.2 millimeters to about 1.0 millimeter. Four flexible blocks 147 are respectively adhered to the four corners of the substrate 141. The flexible blocks 147 extend outward from the four corners along directions corresponding to a moving direction X (seen in FIG. 4) of the lenticular lens screen 140. Each flexible block 147 is made of soft and resilient material, and is configured for reducing damage or deformation of the lenticular lens screen 140 which may otherwise occur due to long use.

The optical portion 143 of the lenticular lens screen 140 includes a plurality of elongated lenses 143a, arranged side by side substantially parallel to each other on an upper surface 141a of the substrate 141. Each elongated lens 143a includes a top portion (not labeled) in the form of a cylindrical lens. The optical portion 143 is configured for adjusting the light emitted from the LCD panel 130 so that the light reaches the viewer at precise desired angles. That is, when the viewer's eyes are within the range of angles whereby the entire graphic visual image can be seen, the viewer's left eye will only see left-eye images, and the viewer's right eye will only see right-eye images, the left-eye images and the right-eye images together constituting a whole composite graphic visual image. Thus the two dissimilar images projected from the optical portion 143 realize a three-dimensional impression of the whole composite image as perceived by the viewer.

The driving assembly 150 includes two opposite coils 151, two pairs of first magnets 153, and four pairs of second magnets 155.

The two pairs of first magnets 153 are symmetrically disposed on two opposite edges of the substrate 141. Each pair of the first magnets 153 are symmetrically and respectively adhered on the upper surface 141a and a bottom surface 141b of the substrate 141. Each first magnet 153 is configured for providing steady and constant magnetic force to alternately attract and repel a corresponding adjacent coil 151. In the present embodiment, one pair of the first magnets 153 attract the corresponding adjacent coil 151, while simultaneously the other pair of the first magnets 153 repel the corresponding adjacent coil 151.

The two opposite coils 151 are fixed on the inner surface of the enclosure 110, and are configured for reacting to the magnetic force of the first magnets 153. The two coils 151 are both electrically connected to a power source 157, and have windings wrapped in opposite directions, respectively. When the power source 157 supplies a direct current to the coils 151, the coils 151 generate opposite magnetic fields to react to the magnetic fields of the first magnets 153. Therefore, when one of the coils 151 attracts the corresponding first magnets 153 and the other coil 151 simultaneously repels the corresponding first magnets 153, all the first magnets 153 drive the substrate 141 to move along a particular desired direction such as the direction X. As such, when the power source 157 supplies an alternate current to the coils 151, the magnetic field generated by each of the coils 151 is synchronously and repeatedly reversed at a frequency corresponding to the frequency of the alternate current provided by the power source 157. In this way, the first magnets 153 drive the substrate 141 to move back and forth along directions corresponding to the X direction. In the present embodiment, the frequency of the alternate current provided by the power source 157 is controlled to be at least 60 Hertz (Hz), which is in the range of persistence of vision for the human eye.

The four pairs of second magnets 155 are disposed at two other opposite edges of the substrate 141 symmetrically. In particular, four second magnets 155 are fixed on the upper and bottom surfaces 141a, 141b of the substrate 141, and the remaining four second magnets 155 are fixed on the inner surface of the enclosure 110. Thus, two pairs of second magnets 155 are symmetrically fixed on the opposite edges of the substrate 141. The other two pairs of second magnets 155 are fixed on the enclosure 110. When the driving assembly 150 is in a passive state, the second magnets 155 on the substrate 141 are located directly opposite corresponding second magnets 155 on the enclosure 110. The second magnets 155 on the enclosure 110 produce magnetic fields that attract or repel the second magnets 155 on the substrate 141, whereby the substrate 141 can be kept in balance even when the substrate 141 is driven to move back and forth along the directions corresponding to the X direction.

Alternative embodiments include the following. The first magnets 153 and the coils 151 may be positioned in other ways. For example, each two of the first magnets 153 which are positioned on a same upper or bottom surface 141a, 141b of the substrate 141 can have opposite magnetic fields. In such case, the coils 151 have a same winding direction. Furthermore, the number of first magnets 153 can be reduced to two. For example, the two first magnets 153 can be disposed on a same upper or bottom surface 141a, 141b of the substrate 141. In another example, the two first magnets 153 can be respectively disposed on the upper and bottom surfaces 141a, 141b of the substrate 141, respectively, whereby they are diagonally opposite each other across a middle of the substrate 141.

When the power source 157 provides an alternate current to the coils 151, the coils 151 generate alternate magnetic fields to attract or repel the first magnets 153 alternately. Thus, the first magnets 153 can move the lenticular lens screen 140 relative to the LCD panel 130. Also, due to the frequency of the alternate current of the power source 157 being controlled to be in a range corresponding to a frequency that achieves persistence of vision for the human eye, the lenticular lens screen 140 moves relative to the LCD panel 130 at a frequency that achieves persistence of vision of the graphic visual images displayed.

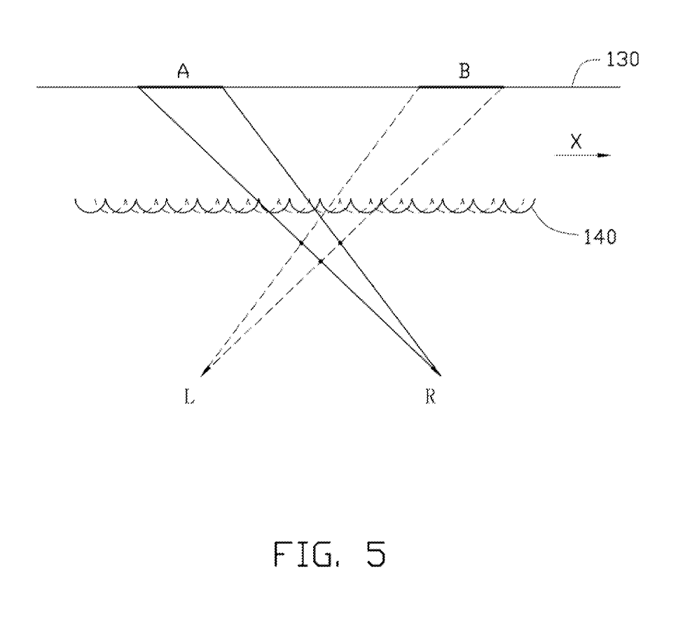

Referring to FIG. 5, the movable lenticular lens screen 140 stacked on the LCD panel 130 forms the stereoscopic display device 100 for viewing three-dimensional (3-D) images. That is, when the lenticular lens screen 140 is moved to and oriented at a position for right eye viewing of the 2-D graphic visual image for right eye vision displayed by the LCD panel 130, only the right eye R of the viewer is able to observe the image displayed on the LCD panel 130. In FIG. 5, viewing according to the right eye viewing position is illustrated with an exemplary portion A of the 2-D graphic visual image displayed on the LCD panel 130, and with solid lines representing optical paths of light corresponding to the portion A. Conversely, when the lenticular lens screen 140 is moved to and oriented at a position for left eye viewing of the 2-D graphic visual image for left eye vision displayed by the LCD panel 130, only the left eye L of the viewer is able to observe the image displayed on the LCD panel 130. In FIG. 5, viewing according to the left eye viewing position is illustrated with an exemplary portion B of the 2-D graphic visual image displayed on the LCD panel 130, and with broken lines representing optical paths of light corresponding to the portion B. As such, when the two dissimilar 2-D graphic visual images are viewed through the lenticular lens screen 140 moved between the right eye viewing position and the left eye viewing position at a rate of at least 60 Hz, a 3-D image is perceived by the viewer.

While various exemplary and preferred embodiments have been described, it is to be understood that the disclosure is not limited thereto. To the contrary, various modifications and similar arrangements (as would be apparent to those skilled in the art) are also covered. Therefore, the scope of the appended claims should be accorded the broadest interpretation so as to encompass all such modifications and similar arrangements.

What is claimed is:

1. A stereoscopic display device comprising:
an enclosure;
a liquid crystal display (LCD) panel received in the enclosure and configured for consecutively displaying a plurality of images;
a lenticular lens screen positioned in front of the LCD panel for viewing by a viewer, the lenticular lens screen comprising a substrate and an optical portion formed on the substrate, the optical portion configured for transmitting the light rays from the LCD panel to the viewer at angles corresponding to a right eye viewing position of the viewer and at angles corresponding to a left eye viewing position of the viewer; and
a driving assembly connected to the substrate and configured for moving the lenticular lens screen back and forth relative to the LCD panel at a predetermined frequency to show the images to the right eye viewing position and to the left eye viewing position alternately at the predetermined frequency.

2. The stereoscopic display device of claim 1, further comprising a backlight module comprising a light emitting surface abutting the LCD panel and configured for transmitting uniform and continuous light rays to the LCD panel.

3. The stereoscopic display device of claim 2, wherein the LCD panel is supported on the backlight module.

4. The stereoscopic display device of claim 1, wherein the images are 2-D graphic images captured for right eye viewing and left eye viewing, respectively, or a plurality of synthesized stereoscopic images.

5. The stereoscopic display device of claim 1, wherein the substrate of the lenticular lens screen is made of transparent glass.

6. The stereoscopic display device of claim 1, wherein the substrate is substantially rectangular shaped, and the length and width of the substrate are substantially the same as those of the LCD panel.

7. The stereoscopic display device of claim 1, wherein the substrate is parallel to the LCD panel, and a gap is defined between the substrate and the LCD panel for avoiding friction that would otherwise occur between the substrate and the LCD panel.

8. The stereoscopic display device of claim 7, wherein the width of the gap is in a range from about 0.2 millimeters to about 1.0 millimeter.

9. The stereoscopic display device of claim 1, wherein a plurality of flexible blocks are disposed on corners of the substrate, and the flexible blocks extend outward from the corners along directions corresponding to moving directions of the lenticular lens screen.

10. The stereoscopic display device of claim 9, wherein each of the flexible blocks is made of soft and resilient material.

11. The stereoscopic display device of claim 1, wherein the optical portion of the lenticular lens screen comprises a plurality of elongated lenses arranged side by side on an upper surface of the substrate, each of the lenses comprising a top cylindrical lens portion.

12. The stereoscopic display device of claim 1, wherein the driving assembly comprises two opposite coils and a plurality of first magnets, the first magnets are symmetrically fixed on two opposite lateral edges of the substrate, and the two opposite coils are fixed on an inner surface of the enclosure and are respectively adjacent to the first magnets.

13. The stereoscopic display device of claim 12, wherein the two coils are arranged to be capable of being electrically connected to a power source, and have windings wrapped in opposite directions, respectively, and when an alternate direct current is applied to the coils, the magnetic field generated by each of the coils is synchronously and repeatedly reversed at a frequency corresponding to the frequency of the alternate current provided and the first magnets thereby drive the substrate to move back and forth.

14. The stereoscopic display device of claim 13, wherein the driving assembly further comprises a plurality of second magnets symmetrically positioned at another two opposite edges of the substrate, with half of the plurality of second magnets fixed on at least one surface of the substrate and the remaining half of the plurality of second magnets fixed on the inner surface of the enclosure, the second magnets and the coils configured to cooperatively keep the substrate in balance when the lenticular lens screen moves back and forth.

15. The stereoscopic display device of claim 14, wherein the predetermined frequency of the images shown is in the range of persistence of vision for the human eye.

16. The stereoscopic display device of claim 15, wherein the predetermined frequency is at least 60 Hz.

17. A reciprocating lenticular lens screen assembly comprising:
a lenticular lens screen, comprising a substrate and an optical portion formed on a first major face of the substrate for viewing by a viewer at a viewer's position, the optical portion configured for transmitting light rays representing images input to an opposite second major face of the substrate to the viewer's position at angles corresponding to a right eye viewing position of the viewer's position and at angles corresponding to a left eye viewing position of the viewer's position; and
a driving assembly, a part of the driving assembly connected to the substrate, the driving assembly configured for moving the lenticular lens screen back and forth at a predetermined frequency to show the images to the right eye viewing position and to the left eye viewing position alternately at the predetermined frequency.

18. The reciprocating lenticular lens screen assembly of claim 17, wherein the driving assembly comprises two opposite coils and a plurality of first magnets, the first magnets are symmetrically fixed on two opposite lateral edges of the substrate, and the two opposite coils are adapted to be positioned respectively adjacent to the first magnets.

19. The reciprocating lenticular lens screen assembly of claim 18, wherein the two coils are adapted to be electrically connected to a power source, and have windings wrapped in opposite directions, respectively, such that when an alternate direct current is applied to the coils, the magnetic field generated by each of the coils is synchronously and repeatedly reversed at a frequency corresponding to the frequency of the alternate current provided and the first magnets thereby drive the substrate to move back and forth.

20. The reciprocating lenticular lens screen assembly of claim 19, wherein the driving assembly further comprises a plurality of second magnets symmetrically positioned at another two opposite edges of the substrate, with half of the plurality of second magnets fixed on at least one surface of the substrate and the remaining half of the plurality of second magnets adapted to be positioned respectively adjacent to said half of the plurality of second magnets, such that the second magnets and the coils cooperatively keep the substrate in balance when the lenticular lens screen moves back and forth.
